(19) United States
(12) Patent Application Publication
(10) Pub. No.: US 2017/0101124 A1
(43) Pub. Date: Apr. 13, 2017

(54) Steering Wheel Connection Assembly

(71) Applicant: Ford Global Technologies, LLC, Dearborn, MI (US)

(72) Inventors: Birger Assmann, Burscheid (DE); Andre Wilmsen, Koln (DE); Martin Fassbender, Buschhoven (DE)

(73) Assignee: Ford Global Technologies, LLC, Dearborn, MI (US)

(21) Appl. No.: 15/288,604

(22) Filed: Oct. 7, 2016

(30) Foreign Application Priority Data
Oct. 9, 2015 (DE) DE102015219644.5

(51) Int. Cl. B62D 1/10; F16D 1/06

(52) U.S. Cl. CPC B62D 1/10; F16D 1/06

(57) ABSTRACT

A steering assembly, including a steering wheel having a receiving opening arranged on a base member of the steering wheel and a steering rod having an end portion at least partially received in the receiving opening. The receiving opening has an inner contour and the end portion of the steering rod has an outer contour that corresponds to the inner contour. The receiving opening also has a conical expansion located downstream, with respect to an assembly direction of the steering wheel and steering rod, of the inner contour. The steering rod includes a frustoconical transition portion located downstream, with respect to the assembly direction of the steering wheel and steering rod, of the outer contour. The frustoconical transition portion is complementary to the conical expansion of the receiving opening.

### CROSS-REFERENCE TO RELATED APPLICATIONS

Not Applicable.

### BACKGROUND OF THE INVENTION

1. Field of the Invention

The present invention relates to a steering system for a motor vehicle, and more specifically to a steering wheel and steering rod connection.

2. Description of Related Art

Generally, steering wheels and steering rods are produced as separate components connected during the assembly of a vehicle. A direct plug type connection between the steering wheel and steering rod is often used; for example, the steering wheel has a centrally arranged receiving opening, with respect to a steering wheel rim, that receives an end portion of the steering rod.

The plug type connection it may be a releasable connection secured against unintentional separation by a releasable connector, for example, a nut. The connection transmits steering torque applied to the steering wheel to the steering rod without losses, with the regions in engagement having complementary cross section contours.

Depending on the configuration, plug type connections, for example, may have fine-toothed or polygonal contours engaging each other. A polygonal contour allows only incremental orientation of the steering wheel and steering rod. For example, a hexagonal configuration provides six steering wheel placement positions on the steering rod. This configuration provides steering wheel offset in steps of 60° about the longitudinal direction of the steering rod. A fine-toothed arrangement provides a wider variety of possibilities of placement positions for placing the steering wheel on the steering rod.

Orientation between the steering wheel and the steering rod is relevant in that an incorrect position of the steering wheel with respect to the directional stability of the vehicle may occur. The steering wheel is quasi forced by the structure of the plug type connection into a position where the neutral position of the steering wheel (straight-ahead position) does not necessarily correspond to the actual directional stability of the steerable wheels. Incorrect positioning of the steering wheel is known, both from the prototype structure and from the current production of vehicles.

To overcome possible incorrect positioning between the mounted steering wheel and steering rod and consequently between the steering wheel and directional stability, vehicle tracking is generally adjusted. However, in this instance, the maximum possible angle of lock of the steerable wheels changes in a disadvantageous manner so an uneven turning circle in the left and right direction may occur. Further, when assembled, the steering may incorrectly fit on the generally conical end portion of the steering rod. At first, the incorrect fit is not visually perceived, but the incorrect fit of the steering wheel may cause steering wheel disengagement during application of a first steering torque.

To facilitate assembly and correct placement of the steering wheel, separately fitted optical indications are sometimes used on the steering wheel and steering rod. Such optical indications may include a marking arranged at the 12 o'clock position predetermining the required orientation regarding the respective components. However, a correctly orientated plug type connection also depends on observing the markings and bringing the steering wheel and steering rod into alignment with each other precisely during assembly.

With regard to the earlier embodiments of plug type connections between the steering wheel and steering rod, complex finishing operations are sometimes required to overcome the presence of an incorrect positioning. The fitting of optical markings also requires corresponding care during assembly so that an incorrect positioning that occurs due to inattention cannot be excluded completely. Because of this, such plug type connections still leave room for improvement.

### SUMMARY OF THE INVENTION

A steering assembly having a steering wheel and steering rod. The steering wheel has a receiving opening having an inner contour, with the inner contour having at least one planar inner face. The inner contour further has a conical portion. The steering rod has an end portion including an outer contour having at least one planar outer face complementary to the planar inner face of the inner contour. The end portion of the steering rod also has a frustoconical portion, with the frustoconical portion being complementary to the conical portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exploded perspective view of a connection according to the invention.

FIG. 2 is an exploded side, longitudinal partial sectional view of the section of the connection of FIG. 1.

FIG. 3 is a cross section of a first component of the connection of FIGS. 1 and 2.

FIG. 4 is an end view of a second component of the connection from FIGS. 1 and 2.

### DETAILED DESCRIPTION OF THE PREFERRED EMBODIMENTS

The following description of the preferred embodiment(s) is merely exemplary in nature and is in no way intended to limit the invention, its application, or uses.

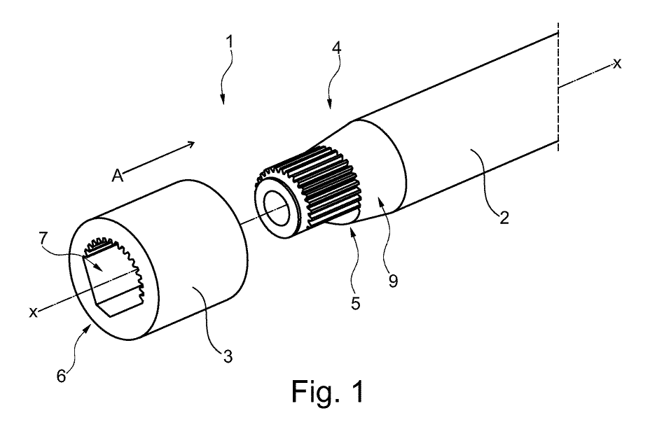

FIG. 1 shows a plug type connection 1 according to the invention. Components of the plug type connection 1 are a steering rod 2 and a base portion or member 3 of a steering wheel, not illustrated in greater detail.

FIG. 1 shows the assembly process between the steering rod 2 and steering wheel, including placing the base member 3 of the steering wheel on the steering rod 2 to transmit torque from the steering wheel to the steering rod 2. FIG. 1 shows a portion of the steering rod 2, in this instance an outer contour 5 of the end portion 4. The base member 3 has a receiving opening 6 that partially receives the end portion 4 of the steering rod 2. As shown, the receiving opening 6 has an inner contour 7 corresponding to the outer contour 5 of the steering rod 2.

Moving the base member 3 of the steering wheel in an assembly direction A, parallel with a longitudinal direction x of the steering rod 2, toward the end portion 4 until the outer contour 5 of the steering rod 2 and the inner contour 7 of the receiving opening 6 are at least partially in engagement produces the plug type connection 1.

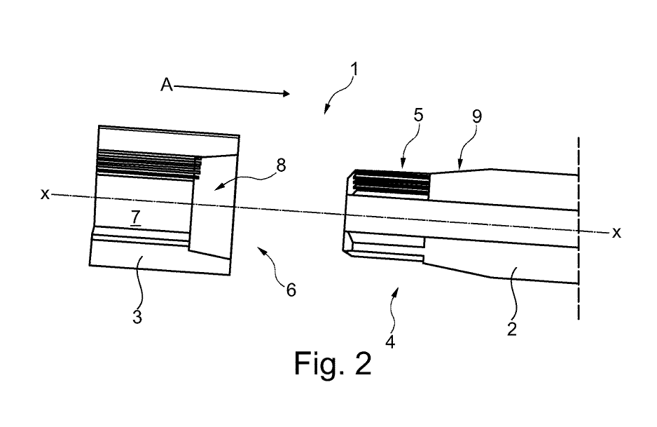

FIG. 2 is a side view of the plug type connection 1 from FIG. 1. The base member 3 and the steering rod 2 are illustrated in a longitudinal section so the respective configuration thereof is shown in greater detail. The inner contour 7 of the receiving opening 6 of the base member 3 and the outer contour 5 of the end portion 4 of the steering rod 2 are constructed in a manner that brings the steering wheel into engagement with the end portion 4 of the steering rod 2 to transmit torque only in a single rotation position about the longitudinal axis x of the steering rod 2.

As seen, the receiving opening 6 of the base member 3 has a conical expansion 8 which, with respect to the assembly direction A of the steering wheel and the steering rod 2, is arranged downstream of the inner contour 7 of the receiving opening 6, i.e., adjacent an end face 22 of the base member 3. The end portion 4 of the steering rod 2 includes a frustoconical transition portion 9 located downstream of the outer contour 5; i.e., between the outer contour 5 and the remaining portion of the steering rod 2 that adjoins the end portion 4. The conical expansion 8 and the frustoconical transition portion 9 are configured such that they correspond and are complementary to each other.

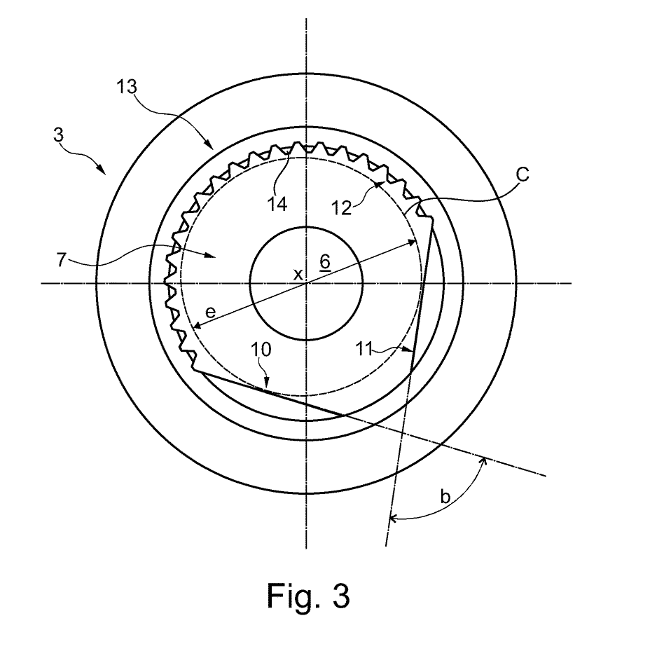

FIG. 3 shows the inner contour 7 of the receiving opening 6 having two planar inner faces 10, 11. The inner faces 10, 11 together define an angle b with a value of from 70° to 90°, where the angle b is, for example, 82°. Furthermore, the inner contour 7 has an internal tooth arrangement 12 arranged on an inner peripheral region 13 of the receiving opening 6 opposite the angle b between the planar inner faces 10, 11, wherein the internal tooth arrangement together with the planar inner faces 10, 11 create the complete inner periphery of the inner contour 7. The internal tooth arrangement 12 has splines 14 extending in the longitudinal direction x of the receiving opening 6 and arranged adjacent each other along the inner peripheral region 13 of the receiving opening 6.

As shown, the receiving opening 6 describes an inner circle C delimited by the planar inner faces 10, 11 and at least one spline 14 of the internal tooth arrangement 12. The inner circle C having a diameter e represents a largest possible cross section of a notional round rod (not shown) that could be introduced into the receiving opening 6.

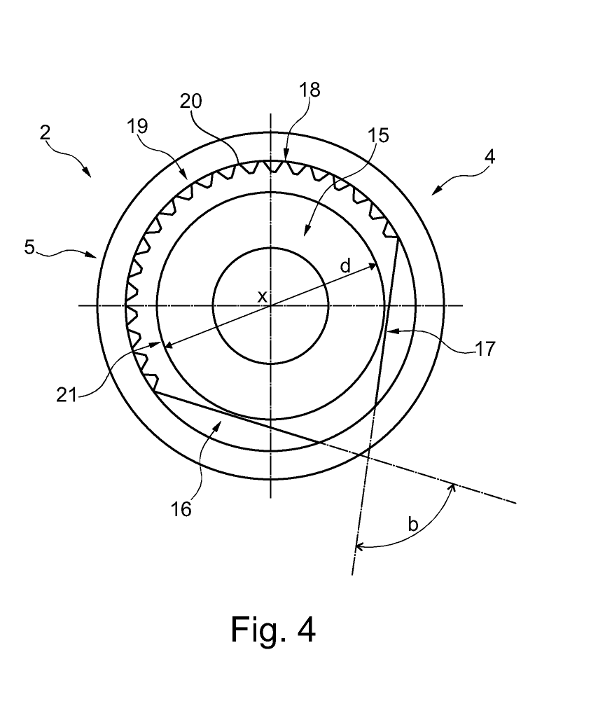

FIG. 4 shows an end face 15 of the end portion 4 of the steering rod 2. As seen, the outer contour 5 of the end portion 4 is adapted in terms of its configuration to the inner contour 7 of the receiving opening 6 of the base member 3.

The outer contour 5 of the steering rod 2 has two planar outer faces 16, 17. The outer faces 16, 17 together define an angle b with a value of from 70° to 90° that corresponds to the angle b between the inner faces 10, 11. The outer contour 5 has an external tooth arrangement 18 which corresponds to the internal tooth arrangement 12 and which is arranged on an outer peripheral region 19 of the end portion 4 opposite the angle b between the planar outer faces 16, 17. The external tooth arrangement 18 has grooves 20 which extend in the longitudinal direction x of the steering rod 2 and which are arranged beside each other along the outer peripheral region 19 of the end portion 4. The end portion 4 of the steering rod 2 further has a chamfer 21 arranged in a peripheral manner on the free end thereof and which tapers the end portion 4 in the direction toward the end face 15 of the steering rod 2 in such a manner that an outer diameter d of the end face 15 of the steering rod 2 is smaller than inner diameter e of the inner circle C of the receiving opening 6.

The steering wheel has a base member 3 having a receiving opening 6. The receiving opening 6 configured to at least partially receive an end portion 4 of the steering rod 2. The plug type connection 1 has a suitable cross section contour enabling transmission of steering torque applied to the steering wheel to the steering rod without any losses. As shown, the receiving opening 6 of the steering wheel has an inner contour 7 and the end portion 4 of the steering rod 2 has an outer contour 5 complementary to the inner contour 7. As shown, the inner contour 7 and outer contour 5 are constructed in such a manner that the steering wheel can be brought into engagement with the end portion 4 of the steering rod 2 to transmit torque only in a single rotation position about a longitudinal axis of the steering rod 2. The configuration of the contours 5, 7 of the plug type connection 1 permit only a single position relative to each other in which the steering wheel can be placed on the steering rod.

The configuration reduces the risk of incorrect assembly and a possible incorrect positioning of the steering wheel on the steering rod and/or incorrect fit of the steering wheel on the end portion of the steering rod is/are now minimized, and more specifically can be eliminated. The foregoing achieves a substantial simplification, as the assembly now requires only the single fitting position to be found with respect to each other. If the single possible position is not achieved, the assembly of the steering wheel cannot be (incorrectly) completed.

The foregoing assembly does not require optical markings to predetermine the correct orientation. Because of the single possible assembly orientation, incorrect fit or placement of the steering wheel cannot be achieved since constructing the plug type connection advantageously no longer allows an incorrect connection, thereby removing any error in the alignment between the steering wheel and steering rod.

As shown, the plug type connection 1 may include corresponding planar faces 16, 17. The outer contour 5 of the steering rod 2 may have at least one planar outer face 16, 17, while the inner contour 7 of the receiving opening 6 may have at least one corresponding planar inner face 10, 11. The inner face 10, 11 of the receiving opening 6 and the outer face 16, 17 of the outer contour 5 complement each other so, in the assembled state of the steering wheel and steering rod, they at least partially achieve a planar contact with respect to each other. Alternatively, a linear contact between the faces is also conceivable.

Regarding the otherwise symmetrical configuration of the contours of such plug type connections, which are in engagement with each other, the arrangement of the planar faces enables only a single orientation for assembly. The mutually corresponding planar faces in the plug type connection are brought into alignment with each other for positioning the steering wheel on the steering rod. The planar faces represent a structural alternative to the purely optical markings. As opposed to optical markings, the faces cannot be “overlooked,” since they necessarily must be located by means of a relative rotation between the steering wheel and steering rod in order to carry out the assembly.

In one example, the plug type connection 1 includes more than one planar face on the components intended to be connected. In a preferred manner, both the receiving opening 6 of the steering wheel and the end portion 4 of the steering rod 2 each have two planar faces defining an angle between them. As shown, the angle b between the planar inner faces 10, 11 of the receiving opening 6 and the angle b between the planar outer faces 16, 17 of the steering rod 2 may be constructed to be identical. The mutually corresponding faces 16, 17 of the steering rod 2 and the faces 10, 11 receiving opening 6 of the steering wheel lead to the end portion 4 of the steering rod 2 being at least partially arranged with the planar faces 16, 17 thereof between the planar faces 10, 11 of the receiving opening 6. The steering wheel is supported against one of the faces regardless of the respective rotation direction thereof, enabling transmission of the steering torque to the steering rod. In addition, the arrangement of two planar faces structurally predetermine the orientation of the respective plug type connection 1 components, predetermining the single possible assembly position of the steering wheel on the steering rod.

One example of the plug type connection 1 according to the invention includes a tooth or spline/groove arrangement. The arrangement is a mutual engagement of a plurality of components of the regions of the steering wheel and the steering rod that are in contact with each other. Advantageously, the tooth or spline/groove arrangement permits a transmission of the steering torque resulting from a rotation of the steering wheel to the steering rod and permits a relative movement of the steering wheel with respect to the steering rod in the longitudinal direction thereof. In this manner, the steering wheel can be placed on the steering rod with no blockage by the tooth arrangement (and, if necessary, removed therefrom), whereas a rotation movement of the positioned steering wheel is in principle transmitted to the steering rod through the tooth arrangement.

As shown, the outer contour 5 of the end portion 4 of the steering rod 2 includes, at least partially, an external tooth arrangement including grooves and splines extending in the longitudinal direction of the steering rod. The inner contour 7 receiving opening 6 steering wheel includes, at least partly, an internal tooth arrangement corresponding to the external tooth arrangement, having grooves and splines extending in the longitudinal direction of the receiving opening 6. In the assembled state of the steering rod and steering wheel, at least some of the splines of the receiving opening 6 engage, at least partially, one groove on the outer contour 5 of the end portion 4. In a preferred manner, spline and groove arrangement produces a positive-locking connection between the steering wheel and steering rod.

Further, the tooth or spline and groove arrangement of the plug type connection 1 between the steering wheel and steering rod provides many opposing walls of the grooves and flanks of the splines, whereby steering torque acting on the steering wheel can be transmitted in a reliable manner to the steering rod. The mutually corresponding flanks and walls may be inclined in the same manner so the splines and grooves may, for example, have a triangular cross section in each case.

According to another example, the plug type connection 1 may include, with respect to the cross section contour thereof, a combination of a tooth arrangement and planar faces. The planar faces and tooth arrangement provide for placement of the external tooth arrangement 18 of the outer contour 5 of the end portion 4 of the steering rod 2 on an outer peripheral region 19 of the steering rod 2 opposite the angle b between the planar outer faces 16, 17 of the end portion 4. The tooth arrangement may be quasi interrupted by the planar faces 16, 17 facing each other in a V-shaped manner because of the angle b enclosed between them. In this context, the receiving opening 6 may be adapted whereby the internal tooth arrangement 12 thereof is arranged on an inner peripheral region 13 of the receiving opening 6 opposite the angle b between the planar inner faces 10, 11.

Arranging the planar faces on the outer contour 5 of the steering rod 2 and the inner contour 7 of the receiving opening 6 of the steering wheel, provides for them to be located in an advantageous angular range with respect to each other. The planar faces of the plug type connection 1 may thus define an angle of from 70° to 90° between them. In this angular range, a resultant force intended to be transmitted from a steering torque to the inner 10, 11 and outer faces 16, 17 in contact with each other is divided into a force parallel with the faces and a force located perpendicularly to the faces. At an angle of over 90°, the force extending parallel to the faces would increase in value with respect to the force located perpendicularly relative thereto, whereas, at an angle of under 90°, the proportion of the force located perpendicularly to the faces is advantageously predominant. In this instance, the force which quasi lifts the end portion of the steering rod out of the grooves, orientated in a V-shaped manner, with respect to each other is smaller, whereby an improved plug type connection is produced.

The angle between the faces may thus also have a value of from 78° to 84°. In a preferred manner, the angle may be from 80° to 82°.

The combination of the planar faces and the tooth arrangement, results in both a single assembly position and a permanently torque-transmitting plug type connection between the steering wheel and the steering rod.

The plug type connection may preferably be configured in such that a support position of the steering wheel on the steering rod is enabled, one where the respective contours 5, 7 of the plug type connection 1 are not engaged. In this configuration, the steering wheel is supported on the steering rod but can still be freely rotated until the only possible assembly orientation for placing the steering wheel on the steering rod has been found. The location of the assembly orientation becomes noticeable in that the steering wheel quasi “slides” on the steering rod.

In this example, the receiving opening 6 may include an inner circle C delimited by one or both planar inner face 10, 11 and at least one inner spline 14 of the internal tooth arrangement 7. As understood, the inner circle C defines a maximum opening size for a circular rod, which lacking outer contouring, could be introduced into the receiving opening 6 and supported at least partially on at least one spline 14 of the internal tooth arrangement 12 and at least one inner face 10, 11. The steering rod 2 may have a chamfer 21 arranged in a peripheral manner between the end portion 4 and the end face 15. As shown, the chamfer 21 tapers the end portion 4 toward the end face 15 of the steering rod 2. In one example, an outer diameter d of the end face 15 of the steering rod 2 and an inner diameter e of the inner circle C of the receiving opening 6 may have a relationship with each other. For example, the outer diameter d of the end face 15 of the steering rod 2 is smaller than the inner diameter e of the inner circle C of the receiving opening 6.

The tapered tip, the chamfered portion 21, of the steering rod 2 can be partially introduced into the receiving opening 6 although the respective contours of the plug type connection 1 are not engaged. In this manner, the steering wheel can be supported on the steering rod 2 and, with respect to subsequent rotation thereof, at the same time is guided through the steering rod 2 as a rotation axis. The steering wheel is quasi supported on the end-side chamfer 21 of the steering rod 2 until the only possible assembly position has been located.

As shown, the receiving opening 6 of the steering wheel has a conical expansion 8. The conical expansion 8 configured to the cross sectional area or size of the receiving opening 6 to simplify receipt of the steering rod 2. Referring to an assembly direction A of the steering wheel and steering rod, the conical expansion 8 is located downstream of the inner contour 7 of the receiving opening 6. Specifically the conical expansion 8 is between an end face 22 of the base member 3 and the inner contour 7 of the receiving opening 6. As shown the receiving opening 6 ends or terminates at the end face 22 of the base member 3. The conical expansion 8 forms a funnel-like entry region for the introduction and receipt of the steering rod 2. The conical expansion 8 tapers inwardly, toward the longitudinal axis x, in the direction toward the inner contour 7.

Similarly, the end portion 4 of the steering rod 2 includes a frustoconical transition portion 9 between the outer contour 5 and the remainder of the steering rod 2. As shown, the frustoconical transition portion 9 is complementary to the conical expansion 8 of the receiving opening 6.

Besides easing introduction of the steering rod 2 in the receiving opening 6 of the steering wheel, the shown example provides an end stop for fitting of the steering wheel on the steering rod. When the steering wheel is placed on the steering rod 2, the conical expansion 8 of the receiving opening 6 and the frustoconical transition portion 9 of the steering rod 2 move close to each other until they move into at least partial contact. In one example, the conical expansion 8 and the frustoconical transition portion 9 have the same inclination allowing as much planar contact between the two as possible. Cooperation between the conical expansion 8 and the frustoconical transition portion 9 also transmits forces from the steering wheel to the steering rod 2 in the longitudinal direction of the steering rod 2, as may occur, for example, when supporting the person steering the vehicle or in the event of an impact.

The plug type connection 1 as set forth above provides an advantageous possibility for simple and in particular correct assembly of a steering wheel on a steering rod. The plug type connection now formed between a steering wheel and a steering rod structurally predetermines a single possible orientation of the two components with respect to each other. Any incorrect fit of the steering wheel on the steering rod is impossible in this instance.

The advantages afforded thereby have been explained in detail in relation to a plug type connection according to various examples of the present invention. The advantageous configurations and embodiments of the plug type connection as already set out in this context apply accordingly to the steering wheel according to the invention and the steering rod according to the invention. In this regard, combinations of the features previously explained in relation to the plug type connection and the steering wheel according to the invention and the steering rod according to the invention are intended and are claimed accordingly.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A steering assembly comprising:
a steering wheel having a receiving opening including an inner contour and a conical portion, said inner contour has at least one planar inner face;
a steering rod having an outer contour having at least one planar outer face complementary to the planar inner face of said inner contour and a frustoconical portion complementary to the conical portion.

2. The steering assembly of claim 1 including said outer contour having two planar outer faces defining an angle between them; and
said inner contour having two planar inner faces defining the same angle between them wherein each outer face is positioned adjacent a corresponding inner face.

3. The steering assembly of claim 1 wherein said outer contour includes grooves extending in a longitudinal direction of the steering rod and said inner contour includes splines extending in a longitudinal direction of the receiving opening.

4. The steering assembly of claim 3 including grooves on an outer peripheral region of the steering rod opposite the angle between the planar outer faces; and
splines on an inner peripheral region of the receiving opening opposite the angle between the planar inner faces.

5. The steering assembly of claim 2 including said receiving opening having an inner circle, said inner circle delimited by the planar inner faces and at least one of the splines; and
said steering rod having a chamfer arranged in a peripheral manner at an end face of the steering rod, said chamfer tapering the steering rod end portion in a direction toward said end face such that an outer diameter of said end face is less than an inner diameter of said inner circle of the receiving opening.

6. The steering assembly of claim 2 wherein the angle between the planar inner faces and the planar outer faces has a value of from 70° to 90°.

7. The steering assembly of claim 6 wherein the angle is from 80° to 82°.

8. A steering assembly comprising:
a steering wheel having a receiving opening including an inner contour and a conical portion, said inner contour having two planar inner faces defining an angle between them;
a steering rod having a frustoconical portion complementary to the conical portion and an outer contour, said outer contour having two planar outer faces defining the same angle between them wherein each outer face correspond to complementary inner face and;
said outer contour including grooves extending in a longitudinal direction of the steering rod and said inner contour including splines extending in a longitudinal direction of the receiving opening;
said receiving opening including an inner circle, said inner circle delimited by said planar inner faces and at least one of the splines;
said steering rod having a chamfer arranged in a peripheral manner at an end face of the steering rod, said chamfer tapering the steering rod end portion such that an outer diameter of said end face of the steering rod is less than an inner diameter of said inner circle of the receiving opening; and
said angle between the planar inner faces and the planar outer faces has a value of from 70° to 90°.

9. The steering assembly of claim 8 including grooves on an outer peripheral region of said steering rod opposite the angle between the planar outer faces of the end portion; and
splines on an inner peripheral region of the receiving opening opposite the angle between the planar inner faces.

10. A connection between a steering wheel and a steering rod comprising:
a receiving opening arranged on a base member of the steering wheel, said receiving opening at least partially receiving an end portion of said steering rod wherein the receiving opening has an inner contour and said end portion has an outer contour corresponding to the inner contour such that said base member of said steering wheel engages said end portion of said steering rod to transmit torque from said steering wheel to said steering rod;
said receiving opening having a conical expansion located upstream with respect to an assembly direction of the steering wheel and steering rod;
said end portion includes a frustoconical transition portion complementary to said conical expansion of said frustoconical transition portion located downstream, with respect to the assembly direction, of said outer contour of said steering rod.

11. The connection of claim 1 wherein the outer contour of the steering rod has at least one planar outer face and said inner contour of the receiving opening has at least one planar interface wherein said planar inner face of the receiving opening corresponds to said planar outer face of the outer contour.

12. The connection of claim 1 wherein the outer contour has two planar outer faces defining an angle between them; and
said inner contour has two planar inner faces defining the same angle between them wherein each outer face is positioned adjacent and corresponds to an inner face.

13. The connection of claim 1 wherein the outer contour has an external tooth arrangement with grooves extending in a longitudinal direction of the steering rod; and
the inner contour has an internal tooth arrangement with splines extending in a longitudinal direction of the receiving opening.

14. The connection of claim 13 wherein the external tooth arrangement is on an outer peripheral region of the steering rod opposite the angle between the planar outer faces of the end portion; and
the internal tooth arrangement it is on an inner peripheral region of the receiving opening opposite the angle between the planar inner faces.

15. The connection of claim 1 including:
said receiving opening having an inner circle, said inner circle delimited by the planar inner faces and at least one of the splines of the internal tooth arrangement;
the steering rod having a chamfer at an end face of said steering rod, said taper extending toward said end face such that an outer diameter of said end face of said steering rod is less than an inner diameter of said inner circle of said receiving opening of said base member.

16. The connection of claim 2 wherein the angle between the planar inner faces and the planar outer faces has a value of from 70° to 90°.
